(19) United States
(12) Patent Application Publication
(10) Pub. No.: US 2008/0033903 A1
(43) Pub. Date: Feb. 7, 2008

(54) Methods and apparatuses for using location information

(76) Inventors: Andrew Carol, Half Moon Bay, CA (US); Yan Arrouye, Mountain View, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/499,263

(22) Filed: Aug. 4, 2006

(51) Int. Cl. G06F 17/30

(52) U.S. Cl. 707/1

(57) ABSTRACT

Methods, machine readable media and apparatuses which allow searching based on location information. In one exemplary method, a representation of a location is determined from a network connection and the representation of the location is stored in association with a document for use in searching for documents based on location information. In another exemplary method, data representing a geographical location is obtained in response to creating or modifying a document and the data representing the geographical location is associated with the document, wherein the document is capable of being one of a plurality of different types of documents including a text-based document with ASCII characters within the content of the document. Other methods, media, and apparatuses are also disclosed.

### BACKGROUND AND FIELD OF THE INVENTION

The present invention relates to the field of information processing and more particularly to the field of search and retrieval of information such as information stored in a data processing system.

Certain image processing systems have provided some ability to record a location of where a picture was taken. For example, PCT Application No. PCT/US03/020775 describes an imaging system that automatically identifies where images are captured. The system includes an imaging device for capturing images, a GPS module providing location information, a host device that is at least occasionally connected to the imaging device, and an application logic for querying the GPS module for determining location information and for associating each captured image with a location identifier indicating where each image was captured. U.S. Pat. No. 7,010,144 describes a process of embedding location information within data for an image or as data associated with an image. Literature from Adobe Systems describes a platform known as XMP (Extensible Metadata Platform) which has been used to tag photos with GPS location data through a manual process. U.S. Pat. No. 6,593,878 describes an integrated network interface card and a GPS receiver. These examples of the prior art fail to provide a broader platform for use of location information when searching documents and also fail to provide a more universal system for obtaining location information and using that location information in connection with a variety of different types of documents on a user's data processing system. For example, if a user recalls that a text document (e.g. a Microsoft Word document) was created in Santa Cruz, Calif., these prior systems will not allow the user to find that document by using that location information.

### SUMMARY OF THE DESCRIPTION

At least certain embodiments of the present invention relate to machine implemented methods for processing data and for using location information. One exemplary machine implemented method includes determining, from a network connection, a representation of a location and storing the representation of the location in association with a document for use in searching for documents based on the location information. In certain exemplary implementations of this embodiment, the determining of a location from the network connection may be in response to a user's causing of the storing of a document, and the document may be one of a word processing document, a spreadsheet or other text-based documents, such as documents which include character codes such as ASCII character codes or non-image type documents. In other exemplary implementations, the document may be any type of document. In certain exemplary implementations, a plurality of locations may be stored in association with the document, and a representation of the one or more locations may be stored in a metadata database on a storage device which also stores the document. The representation of the location may be stored as metadata along with other metadata of the document, and the metadata in the metadata database may include different types of metadata for different types of documents. In certain implementations of this exemplary embodiment, a data processing system which performs this method may further include a full-text index database which stores full text from the different types of documents. The network connection may be a wireless connection, such as a WiFi connection that specifies a name (e.g. an SSID) which is used to specify a location or a Wireless Personal Area Network (WPAN), such as a network operating under the IEEE Standard 802.15.4. In at least certain embodiments, the representation of the location may be at least one of a name specified by the wireless connection, or a user specified name associated, by an action of the user, with a name specified by the wireless connection, or some other designation of a location based upon the network connection which may be a wired Ethernet connection or other type of wired network connections. In at least certain implementations, an exemplary method may further include receiving a satellite positioning system (SPS) data, such as GPS (Global Positioning System) data, which specifies a further location where a further document was first created or modified. This SPS data may be converted to a user-friendly or more meaningful location information which can be stored in association with a further document as metadata of the further document in the metadata database. At least certain implementations of this exemplary embodiment may further include presenting a user interface to allow inputting of a user specified location name to be associated with the network connection, wherein after the inputting, the user specified location name is the representation of the location which is used as metadata for the document to indicate the creation location or modification location (or viewing location or location of last access, etc.) of the document. Alternatively, other implementations may, under software control, assign a location name to be associated with a network connection, wherein this assigned location name can then be used as metadata for the document.

A method, according to another exemplary embodiment, includes obtaining data representing a geographical location in response to creating or modifying a document and associating the data representing the geographical location with the document, wherein the document is capable of being one of a plurality of different types of documents, including a text-based document with character codes such as ASCII character codes within the content of the document. The obtaining of the data representing a geographical location may be in response to a user's causing of the storing or downloading or viewing (or other presentation) of the document, and the associating may include storing the data representing the geographical location as metadata for the document with other metadata for the document. The metadata may be stored in a data structure, such as a metadata database which is stored on a storage device which also stores the document itself. In at least certain implementations of this exemplary embodiment, the metadata database may include different types of metadata for different types of documents, and wherein a full-text index database stores full text of the different types of documents. The obtaining of the data representing the geographical location may occur through one of determining, from a network connection, the geographical location or deriving the geographical location from SPS coordinates. In at least certain implementations of this exemplary embodiment, the method may further include receiving a search query which includes location data and performing a search using the search query, wherein the location data is used to search a location field in the metadata database and further presenting a result of the search.

In another exemplary embodiment, a machine implemented method includes obtaining data representing a geographical location in response to creating or downloading or storing or presenting a document, and associating the data representing the geographical location with the document, wherein the data representing the geographical location is stored as metadata for the document in a metadata database having different types of metadata for different types of documents. In this exemplary embodiment, an implementation may perform the obtaining of the data in response to a user's causing of the storing of the document, and the obtaining may include at least one of determining, from a network connection, the geographical location or deriving the geographical location from SPS coordinates.

At least certain implementations of this embodiment may further include receiving a search query which includes location data, and performing a search through the metadata database using the search query, wherein the location data is used to search through location fields in the metadata database and further presenting a result of the search. At least certain implementations of this exemplary embodiment may further include performing a search through a full-text index database using the search query. The network connection may be a wireless network connection that specifies a name which is used to specify a location or it may be a wired location based upon a domain name or an IP address which in turn is used to derive a location or otherwise specify a location. The data representing the geographical location may be at least one of a name specified by the wireless connection if a wireless connection is being used, or a user specified name associated, by an action of the user, with a name specified by the wireless connection or wired connection.

At least certain exemplary embodiments of the present invention further include machine readable media which store or otherwise provide executable computer program instructions which when executed by a data processing system cause the data processing system to perform one or more of the exemplary methods described herein. Furthermore, various apparatuses, such as computer systems and other types of data processing systems, are also described herein.

### BRIEF DESCRIPTION OF THE DRAWINGS

The present invention is illustrated by way of example and not limitation in the figures of the accompanying drawings in which like references indicate similar elements.

FIG. 1 is a flowchart which shows an exemplary overview of one embodiment of the present invention. This flowchart may be considered to include two sets of operations: a first set (operations 101, 103 and 105) performed by a first data processing system and a second set (operations 107 and 109) performed by the first data processing system or another data processing system.

FIG. 2 shows a flowchart which indicates how geographical location information may be obtained and associated with one or more documents or files.

FIG. 3A shows a location lookup table which is used to convert from an input data, such as a WiFi network identification name to an output name, which is typically a more user-friendly or more user-meaningful name.

FIG. 3B is a flowchart which shows a method for allowing a user to set up a network and to specify, when the network is set up or thereafter, a user-specified location name to be associated with a particular network being set up.

FIG. 3C is a flowchart which illustrates another method which allows a user to set up a new network connection to have a location name associated with that new network connection.

FIG. 4 shows a table which represents a metadata database illustrating metadata for a document which may be used in one exemplary embodiment.

FIG. 5 is a representation of a list view of a search result according to one exemplary embodiment.

FIG. 6 shows a representation of a map with representations of documents created or modified at various locations on the map.

FIG. 7 shows an exemplary user interface for entering user preferences or system configuration data in connection with location based searching.

FIG. 8 shows a block diagram of a data processing system which may be used with at least certain exemplary embodiments described herein.

FIG. 9 shows a representative network which may be used with certain exemplary embodiments described herein.

FIG. 10 is a flowchart which illustrates a method for capturing metadata and storing the metadata to allow searching of metadata across applications having captured metadata.

FIGS. 11A and 11B show examples of the content of the particular types of metadata for two different types of files.

FIG. 12 shows an example of an architecture for managing metadata according to one exemplary embodiment of the invention.

FIG. 13 is a flowchart showing another exemplary method of the present invention.

### DETAILED DESCRIPTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

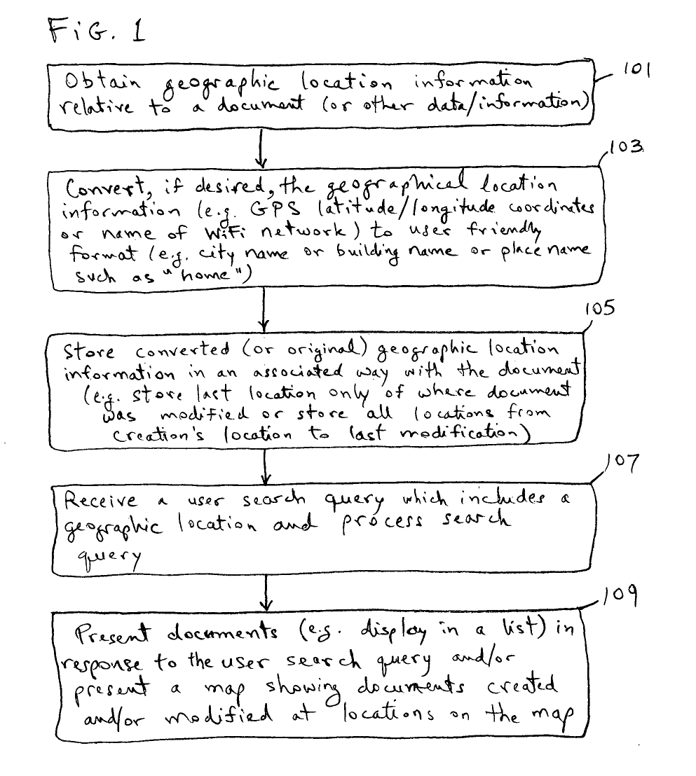

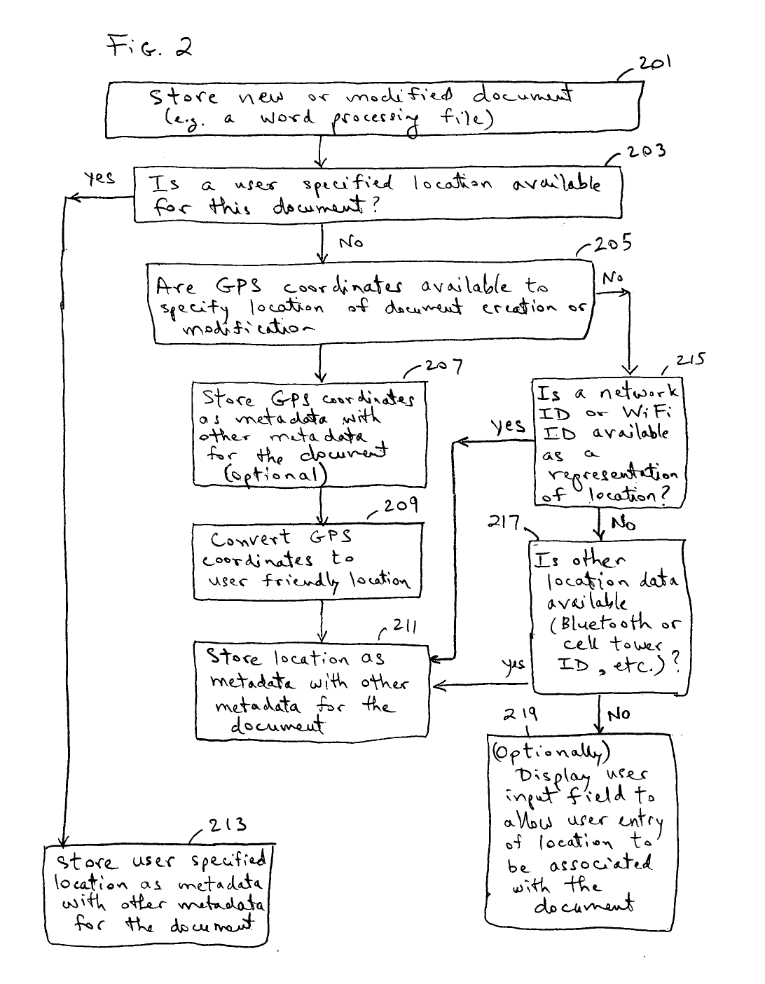

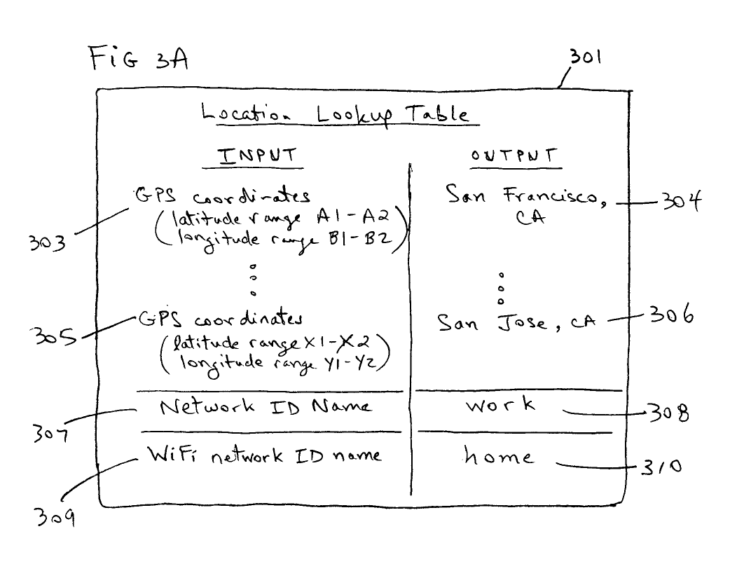

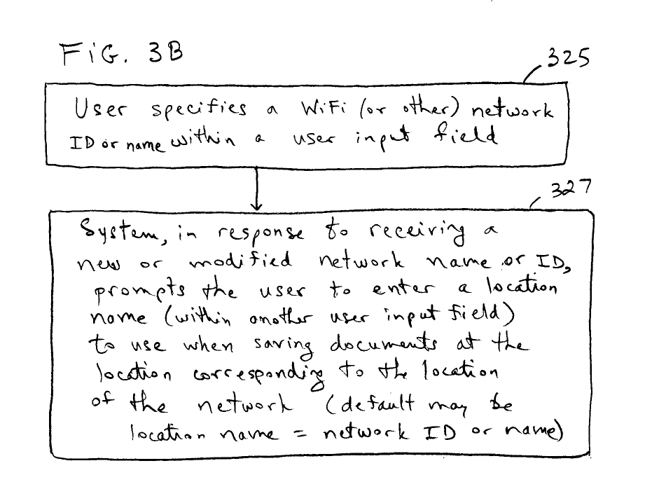

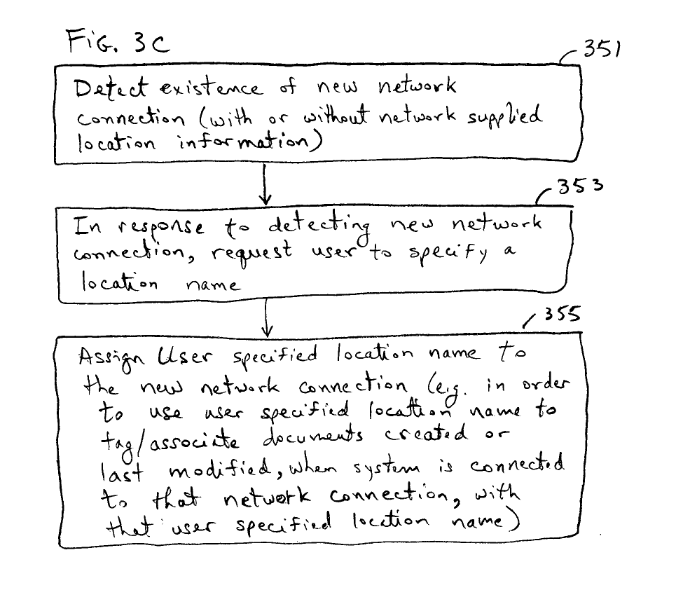

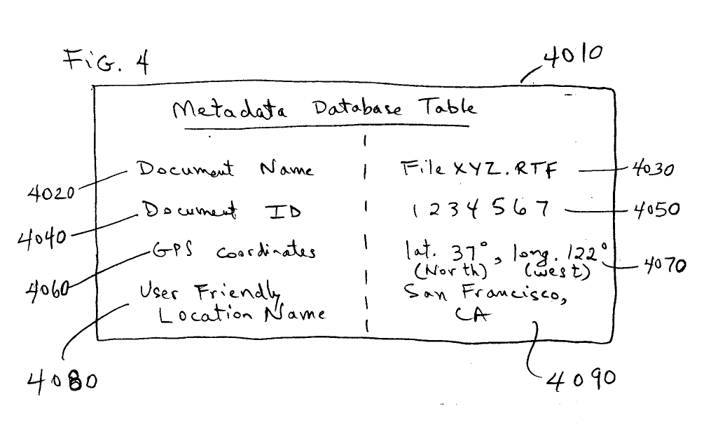

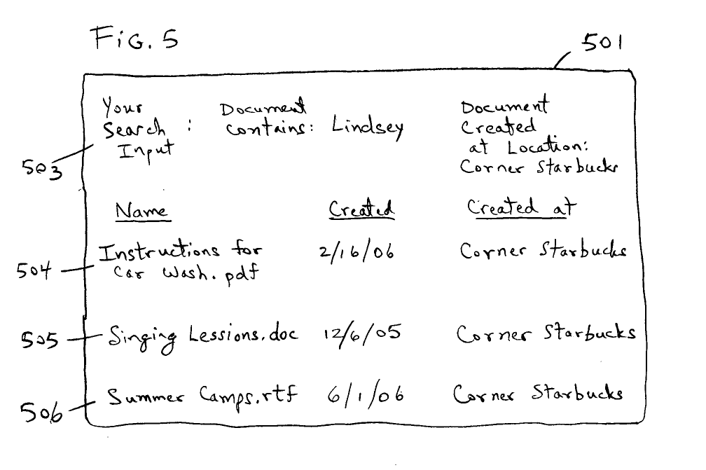

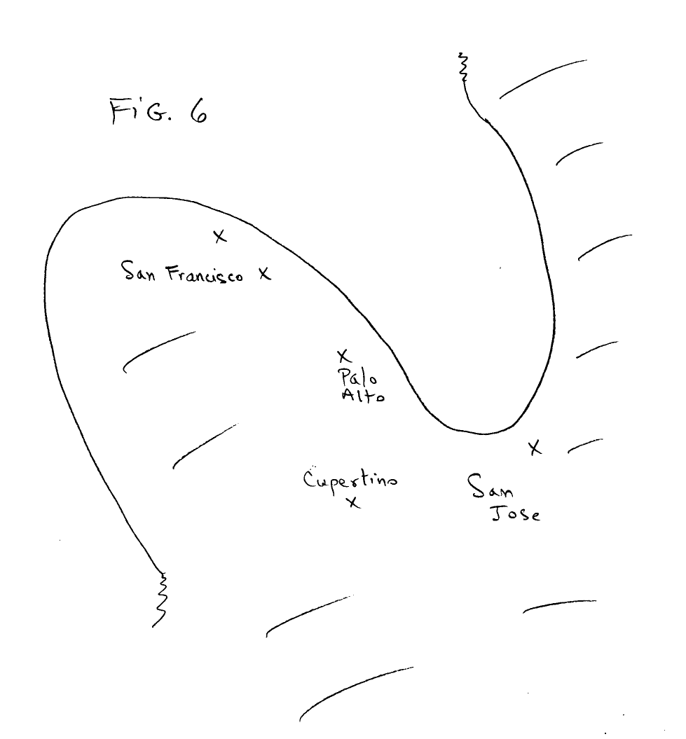

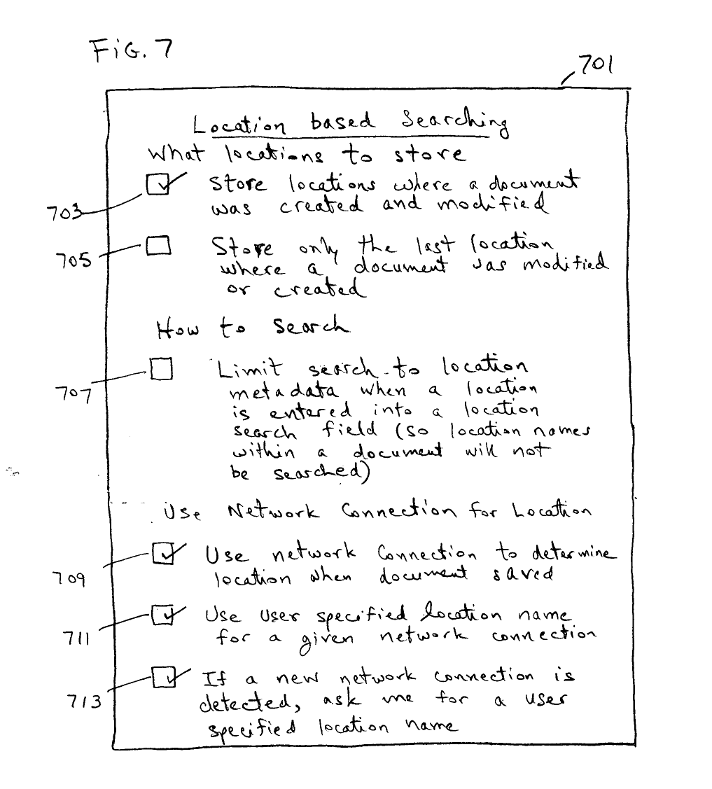

FIG. 1 shows an overview of an exemplary embodiment of the present invention. In operation 101, geographic location information is obtained relative to a document (or other data/information). There are a variety of different ways that the geographic location information may be obtained. FIG. 2 illustrates some of those various ways of obtaining geographic location information. Typically, operation 101 occurs when a document is first created and/or when it is last modified (although in certain embodiments it may occur whenever a document is presented (e.g. viewed or listened to) or it may occur when a document is downloaded or executed (e.g. a Java script)). In certain embodiments, the location information may be obtained only upon the initial creation of the document, or alternatively the location information may be obtained upon the initial creation of the document as well as all subsequent modifications of the document. The creation or modification typically occurs when the user selects “save” or “save as” or similar commands to cause the document to be stored on a data storage device, such as a hard drive. In operation 103, the geographic location information may be converted, if desired, to a more user-friendly format or a more user-meaningful format, such as a city name or building name or place name, such as “home.” FIG. 3A represents a location lookup table which may be used to perform the conversion of operation 103. Operation 105 involves storing the converted or original geographic location information in a way associated with the document. The location information may be stored as metadata with other metadata for the document or may be stored with the document itself in some manner. All locations, from the initial creation location to the last modification may be stored, or merely the last modification location or merely the initial creation location may be stored. FIG. 4 shows an example of a metadata database which includes storage of location information as metadata for a particular document. Operations 107 and 109 may be considered to be a set of operations that are separate from operations 101, 103 and 105. For example, operations 101, 103 and 105 may be performed at a server system (at one point of time) which can be accessed by a client system (at a different point of time) which performs operations 107 and 109. Operation 107 includes receiving a user search query which includes a geographic location and which processes that search query. The processing of this search query may involve using the geographic location as a search query in a location field in the metadata for each document. In operation 109, the documents which were found in response to the user's search query are presented in some user interface, such as the exemplary display shown in FIG. 5 or the exemplary display shown in FIG. 6. The method further may include user interface features which allow a user to specify location names to be associated with certain types of network connections or certain network identification information, such as IP addresses or domain names, etc. Further, the method may include user interfaces, such as that shown in FIG. 7, which allow a user to select preferences or system configurations related to location based searching. One or more exemplary embodiments of the invention may be implemented on a general purpose data processing system, such as a computer system, or a special purpose computer system, or a handheld computer, or a cellular telephone, or a personal digital assistant or a media player (e.g. an iPod) or an entertainment system or other types of data processing systems. At least certain exemplary embodiments may be implemented in the context of a data processing system which includes a metadata database and a full-text database such as those databases described in U.S. patent application Ser. No. 10/877,584 filed on Jun. 25, 2004, the entire content of which is incorporated herein by reference.

The document used in the processing of any one of the various embodiments described herein may be any one of a variety of different types of information or data including a user created file (e.g. a word processing document, a PDF (portable document format) document, a spreadsheet document, a slideshow (e.g. PowerPoint) document, an image or graphic file (e.g. a Photoshop document), etc.) or a system created file or a viewed or presented item (e.g. user viewed or presented web pages, emails, instant messages, MP3 files or other media content files, etc.) or a downloaded file or item (e.g. a downloaded file or item, including executable files or items such as Java downloads or other executables, etc.). In general, the information or data may be any information that can be stored (or be associated with information that was stored) with location information or be associated with location information.

There are a variety of different ways in which location information may be obtained for a new or modified document (or for a document that has been presented or executed or downloaded). The location information may be obtained only upon the initial creation of a document, or when it is modified, or in both instances. Typically, a user will cause a document to be stored by selecting a “save” or “save as” command, and this operation is represented as operation 201 in FIG. 2. In response, the system determines whether a user specified location is available for this document, as shown in operation 203 or the system may prompt the user to enter a user specified location. A user specified location may be available if a user interface was presented to the user to allow the user to enter a user specified location for the document at the time of saving the document. If this user specified location is available, then processing branches to operation 213, in which the user specified location is stored as metadata with other metadata for the document. If such a user specified location is not available, then processing continues to operation 205, in which it is determined whether or not GPS coordinates or other types of satellite positioning system coordinates are available to specify the location of the document's creation or modification. If the GPS coordinates are available, then processing proceeds to operation 207 in which the GPS coordinates are stored as metadata with other metadata for the document. It will be appreciated that the storage of the GPS coordinates is an optional operation, as these coordinates may be discarded after converting the coordinates, in operation 209, to a more user-friendly location. Then in operation 211, the location is stored as metadata with other metadata for the document. FIG. 4 illustrates an example of a metadata database containing location metadata for a particular document. It will be appreciated that there may be a plurality of documents, each having location metadata associated with each document. If, in operation 205, it is determined that GPS coordinates are not available, then processing may branch to operation 215 in which it is determined whether or not a network identifier (ID) or a WiFi identifier (or other identifiers of WLAN (Wireless Local Area Network) or a WPAN (Wireless Personal Area Network) is available as a representation of a location. As is known in the art, WiFi networks typically include a network name (e.g. a Service Set Identifier, which is referred to as an SSID) which is received by clients connected through the network to a WiFi basestation. This name (which is typically broadcast by access points in a WiFi network) may be used as a location or it may be converted to a more user-friendly location name. Some WPANs, such as wireless networks using the IEEE 802.15.4 standard, are also capable of providing location information which may be used in embodiments of the invention. Wired networks may provide fixed IP addresses or other types of IP addresses or domain names from which a location may be derived. Some DNS (Domain Name Server) hosts will provide location information. Further, a “whois” query from a system may provide domain related location information. A traceroute network tool can be used to find through which routers packets flow and thereby identify the location of the receiving machine. Also, Reverse DNS lookup can help determine the country. The name may be a set of alphanumeric characters, such as “Corner Starbucks” or “10.57.40.40,” etc. If, in operation 215, it is determined that a network identifier or a WiFi identifier or other type of network identifier is available as a representation of location, then processing proceeds to operation 211 in which the location data is stored as metadata with other metadata for the document. If, on the other hand, such identifiers are not available, as determined in operation 215, then processing proceeds to operation 217 in which it is determined whether or not other location data is available, such as location data associated with a Bluetooth connection or with a cellular telephone tower, etc. It is known in the art that cell phone towers typically provide identification information which may be used to derive a location information; similarly, Bluetooth locations (or locations derived from access points or other nodes in a WPAN) may be used to indicate the proximity to a particular Bluetooth or other transceiver which in turn can be used to derive a location information. If such location data is available as determined in operation 217, then processing proceeds to operation 211. On the other hand, if such location data is not available, then processing proceeds to operation 219, which is optional, and which displays a user input field to allow user entry of location data to be associated with the document.

It will be appreciated that certain implementations may utilize fewer operations than that shown in FIG. 2 or more operations than that shown in FIG. 2. Further, certain implementations may perform the operations in a different order. Also, as noted above, the derivation of location information may be performed each time that the document is modified and each additional location may be added as metadata, or only the last modification location is saved rather than all modification locations. In certain embodiments, a system may store only the initial creation location and the last modification location; in this case, the method of FIG. 2 is implemented each time the document is saved, but only the last modification location is retained in the database along with the initial creation location.

FIG. 3A shows an example of a lookup table which may be used to perform a conversion, such as the conversion of operation 209 in FIG. 2, or the conversion shown in operation 103 shown in FIG. 1. The table 301 of FIG. 3A includes an input side having entries 303, 305, 307, and 309 and an output side including entries 304, 306, 308, and 310. GPS coordinates in a certain range shown by entry 303 are translated to the output location of San Francisco shown by entry 304. Similarly, input GPS coordinates shown by entry 305 are translated to the output location of San Jose, Calif., which is entry 306. The conversion of GPS or other data to named locations could be hierarchical. For example, a search query of “Bay Area” may, in this case, retrieve not only “Bay Area” matches but also Cupertino matches/hits. Photos from your vacation in Paris may be found based on “Paris” as a search query as well as search queries using either “France” or “Europe” in this case. Similarly, the entry 307 represents a network identifier name, which may be a static IP address or some other network identifier, such as a domain name in a wired network connection which is determined by the system and then used in a conversion operation from entry 307 to the entry 308 which indicates the user-friendly location name of “work.” Finally, in the case of a WiFi network, a WiFi network identifier name shown as entry 309 may be converted to a user-friendly location name shown as entry 310, which in this case is “home.” It will be appreciated that in each case, the output side of the lookup table represents the user-friendly location name which would normally be stored in the metadata database along with other metadata for the particular document. In certain embodiments, the input side of table 301 may be stored in the metadata database and the conversion may be performed before presenting a list of search results in a user interface to the user. In certain implementations of at least some embodiments, location data could be extracted from phone numbers in documents or other data. For example, the phone numbers in a document or an address entry of the form 408-xxx-xxxx indicate a location in the Bay Area (San Francisco Bay Area). This would enable a user to search for “Boston” by finding documents (including address book/contact entries) which have Boston phone numbers (e.g. 617-xxx-xxxx).

FIG. 3B shows an exemplary method in which a user, when setting up a network connection, can specify a location name to be associated with the particular network being set up. For example, when setting up a WiFi or other network, the user may be required to specify a network name or other parameter for the network. This is often done in a user input field as shown in operation 325, in which a user specifies a WiFi or other network identifier or name within a user input field. In response, in operation 327, the system prompts the user to enter a location name, within another user input field, to use when saving documents at the location corresponding to the location of the network. In certain embodiments, the default may be such that the location name is the same as the network identifier or name. For example, if the network is a WiFi network and the user has specified the name of “home WiFi” as the WiFi network's name, then the default name may be “home WiFi.”

FIG. 3C shows an example of how a data processing system may prompt a user to specify a user location name upon detecting the existence of a new network connection. In doing so, the system may then use the user specified location name when new or modified documents are being saved while the system is connected to such network connection. In operation 351, the system detects the existence of a new network connection which may or may not have network supplied location information. For example, the system may detect the presence of a new WiFi network or detect the presence of a wired Ethernet connection or detect the presence of a Bluetooth network or a wireless cell phone network connection. In response to detecting this new network connection, the system, in operation 353, requests the user to specify a location name. This user specified location name is assigned, in operation 355, to the new network connection such that the user specified location name is used to tag documents created or last modified when the system is connected to this network connection. This tagging or association may be performed by storing the user specified location name as metadata with other metadata for the document.

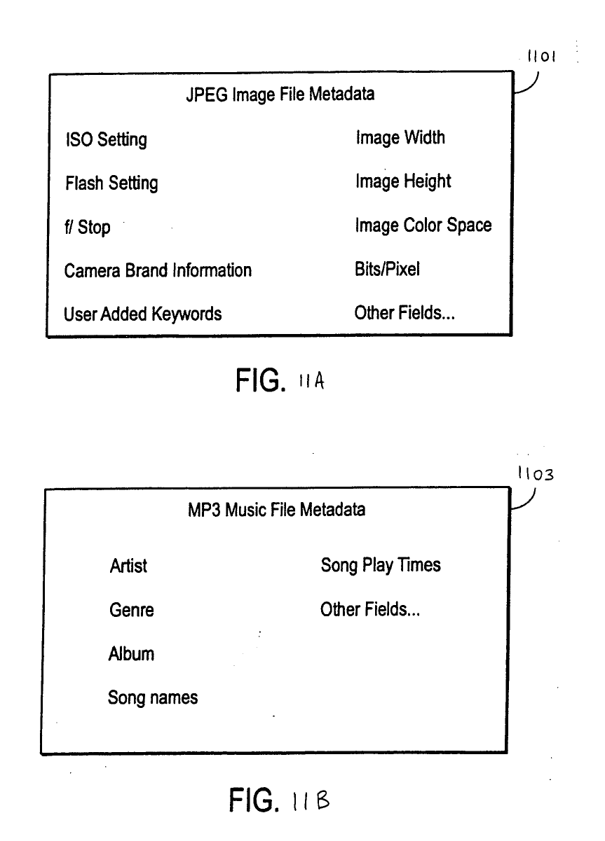

FIG. 4 shows an example of the storing of metadata which may be in a metadata database shown in table form in FIG. 4. The metadata database includes attributes having names which represent fields in the metadata database. Fields 4030, 4050, 4070, and 4090 correspond to the document name, document identifier, GPS coordinates, and user-friendly location name (if available; in certain embodiments, a user-friendly location name may not be available), respectively. The document name may be the name specified by the user and includes an extension, such as “.rtf.” The document ID shown in field 4050 may be a unique, persistent file identifier used in certain operating systems or file systems to label a document or file with a unique and persistent file identifier. The GPS coordinates field 4070 show the GPS coordinates when the document was initially created or modified. The user-friendly location name field 4090 (if available) shows the converted name obtained from those GPS coordinates, which in this case was San Francisco, Calif. Such metadata may exist for each and every file maintained in the metadata database. Further, as shown in FIGS. 11A and 11B, additional metadata is included for certain types of documents. As can be seen from FIGS. 11A and 11B, the type of information in metadata for one type of document may be completely different from the type of information in metadata for another type of document. This additional metadata may be stored also along with the metadata for a document which includes the location metadata, such as that shown in FIG. 4.

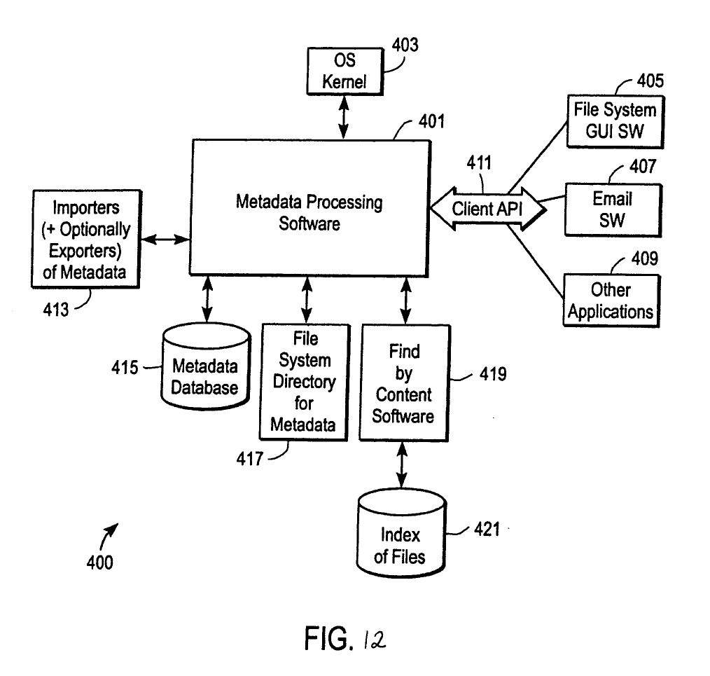

FIGS. 5 and 6 show examples of user interfaces which may be used to present location information about documents. FIG. 5 shows a list view which is the output of a search result, and FIG. 6 is a map (of the San Francisco Bay area) which shows an alternative view of a search or other processing of location data to show the location of the creation or modification of various documents on a map. In the case of FIG. 5, a window 501 presents the search input 503 to the user and also presents a list of documents or files obtained based upon the search input 503. The search input 503, as shown in FIG. 5, included a search for documents which contained, within the content of the document, the name Lindsey and also contain, as the location for the creation of the document, “corner Starbucks.” In response to this search input, the system found three documents 504, 505, and 506 shown in the list of the window 501. The list includes the name of the document, the creation date of the document and the location the document was created at, in this case, the “corner Starbucks.” As can be seen from FIG. 5, the search found three text-based documents of three different types. In particular, it found a PDF (Portable Document Format) file, a “.doc” file (typically a Microsoft Word file), and an “.rtf” file. Each of these files contains the name Lindsey within the content of the file and each of these were created at the corner Starbucks. Thus the user was able to find, by searching on the content within a document, which included text documents, those files which contained the name Lindsey within the content and which were created at the corner Starbucks. The search may be performed through both a metadata database as well as a full-text content index (in an inverted index of the full text of the content of files) of files in an architecture which is similar to the architecture shown in FIG. 12 below.

FIG. 6 represents a map user interface which displays documents (indicated by a “X”) on the map at various locations of the map indicating where various documents were created or last modified or otherwise modified. It can be seen from the map of FIG. 6 that at least two documents were created or modified in San Francisco, one document was created or modified in Palo Alto, one document was created or modified in Cupertino, and one document was created or modified in San Jose, Calif.

FIG. 7 represents a user interface which allows a user to set user preferences or system configuration values for location based searching. This user interface may allow a user to specify what locations to store, how to search, and how to use network connections for location information. Check boxes 703 and 705 allow a user to select between either storing locations where a document was created and modified or storing only the last location where a document was modified or created. Typically, check boxes 703 and 705 would be mutually exclusive, such that if one was checked, the other would become unchecked. Checking box 703 would cause the system to store all locations where a document was created and modified, whereas checking box 705 would cause the system to store only the last location where a document was modified or, if it has not been modified, where it was created. Thus, checking box 705 would restrict the amount of location information stored as metadata for the document. In alternative embodiments, location information may be stored when a document (e.g. a web page or media file, such as an MP3 music file or a movie file) is presented (displayed or played back) to a user or when a document is downloaded or deleted rather than when it is created and modified; in yet other alternative embodiments, location information may be stored when all (or a subset of all) of these operations (creating, modifying, presenting, downloading, executing, or even deleting) is performed, and a user interface (UI) which is similar to that UI shown in FIG. 7 may be used to select which operations are included in the subset. Further, the UI may allow the selection of which types of documents have location information associated with them.

The box 707 in the window 701 allows the user to limit searching to location metadata when a location is entered into a location search field. This will limit searching such that when a user enters a location name within a location search field, that location name will not be searched against location names within a document. In other words, location names entered within a location field are compared against location names within the location field of a metadata database rather than the full-text content of a document which may contain the same location name. Checking box 707 will cause such searching to be limited. Boxes 709, 711, and 713 allow a user to specify how the network connection information is used to derive or use location information. When box 709 is checked, the network connection is used to determine location when the document is saved. Examples of how the network connection is used to determine location are shown in FIG. 2. Thus, if box 709 is checked, then location information is derived from the network connection, such as a WiFi network name when a document is saved. If box 711 is checked, the system then uses a user specified location name for a given network connection rather than a default name, such as the WiFi ID name for a WiFi network. If box 713 is checked, then the system, upon detecting a new network connection, will prompt the user to input a user specified location name; an example of such prompting is shown in FIG. 3C.

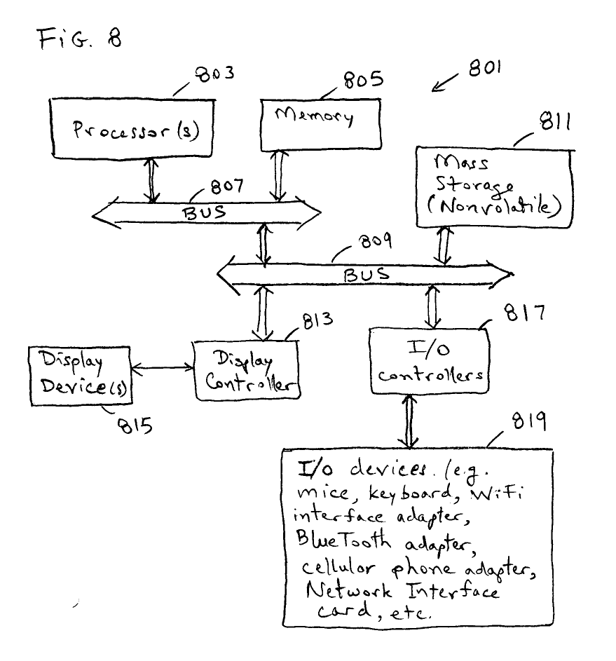

FIG. 8 shows one example of a data processing system which may be used with the present invention. Note that while FIG. 8 illustrates various components of a data processing system, it is not intended to represent any particular architecture or manner of interconnecting the components as such details are not germane to the invention. It will also be appreciated that other types of data processing systems with fewer components or perhaps more components may be used with embodiments of the present invention. For example, an embedded processing device within another device, network computers, personal digital assistants (PDAs), cellular telephones, entertainment systems, media players, a combination of such systems or devices (e.g. a PDA and cellular telephone and a media player in one device) and other data processing systems may also be used with at least certain embodiments of the present invention. The data processing system shown in FIG. 8 may be a general purpose programmable computer such as a Macintosh computer from Apple Computer, Inc. As shown in FIG. 8, the data processing system 801 includes at least 2 buses 807 and 809 which are used to interconnect the various components including a processor, which may be multiple processors 803, memory 805, which may be system RAM which is a volatile form of memory, and a mass storage, such as a hard drive or other non-volatile storage 811. The data processing system also includes a display controller 813 which is coupled to the rest of the system through buses 809 and 807, and the display controller 813 drives at least one display device 815. The system includes one or more input/output (I/O) controllers 817 which allow input/output devices to interface through the controllers with the rest of the system. Examples of such input/output devices include mice, keyboards, WiFi interface adapters, Bluetooth adapters, cellular telephone adapters, network interface cards, etc. The mass storage device 811 is typically a magnetic hard drive or a magnetic optical drive or a flash drive or a DVD RAM or other types of memory systems which maintain data and software even after power is removed from the system. The software may include algorithms and methods to perform one or more implementations described herein. While FIG. 8 shows that the mass storage device 811 is a local device coupled directly to the rest of the components in the data processing system, it will be appreciated that the present invention may utilize a non-volatile memory which is remote from the system, such as a network storage device which is coupled to the data processing system through a network interface such as an Ethernet interface. It will be apparent from this description that aspects of the present invention may be embodied, at least in part, in software. That is, the techniques may be carried out in a computer system or other data processing system in response to its processor, such as a microprocessor, executing in sequences of instructions contained in a memory, such as memory 805 or mass storage 811. In various embodiments, hardwired circuitry may be used in combination with software instructions to implement embodiments of the present inventions.

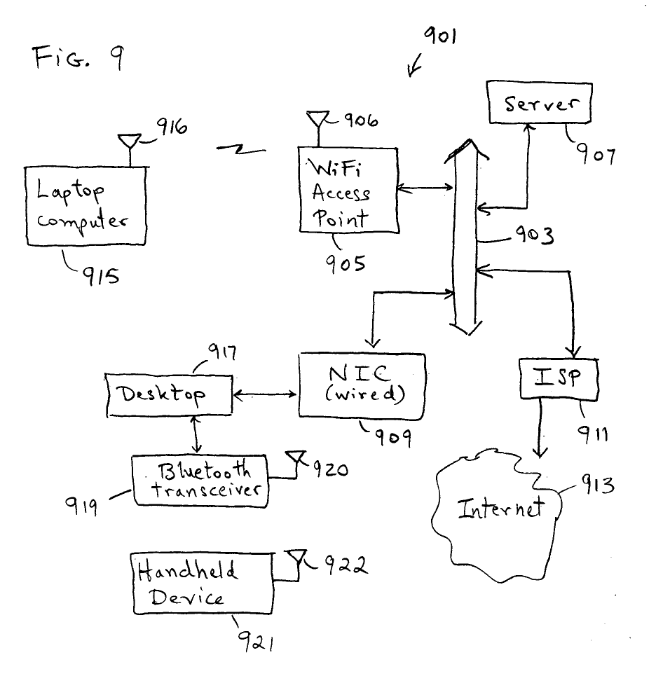

FIG. 9 shows an exemplary network 901 which may be used in at least certain embodiments of the present invention. The network 901 includes a wired network 903 which may be an Ethernet network which couples together a server 907 and a wireless access point 905, which in this case is a WiFi access point 905 which includes a WiFi transmitting and receiving antenna 906. The wired network further includes a network interface card 909 which couples the desktop computer system 917 to the network 903. The network 903 is also coupled to an Internet Service Provider 911 either through conventional telephone lines or fiber optic cables or other mechanisms to couple the network 903 to an Internet Service Provider which, in turn, couples users on the network shown in network 903 to the Internet 913 or to some other network. The WiFi access point 905 is in wireless communication with a laptop computer 915 which includes a WiFi transmitting and receiving antenna 916. The desktop system 917 includes a Bluetooth transceiver 919 which includes a Bluetooth antenna 920, which is in communication with a handheld device 921, which may be a cellular telephone or a PDA (personal digital assistant) which includes a Bluetooth antenna 922. The wireless access point 915 may transmit its WiFi name, also referred to as a WiFi beacon signal, to the laptop computer 915. This will tell the laptop computer that it is coupled to a network through the WiFi access point which has a particular name. This name may in turn be used to tag documents with a location or alternatively a user may specify a user specified location name to be used rather than the WiFi network identifier name. The desktop system 917 may determine its location from a static IP address or domain name for the network provided by the server 907 or some other mechanism utilizing network information generated or maintained for the network 903, which information is available to the desktop computer 917. Thus, the desktop system 917 can derive its location information through the network interface card 909. The handheld device 921 may derive its location information through the network connection which in this case is a Bluetooth network between the Bluetooth transceiver 919 and the handheld device 921. Hence, one or more different types of network connections may be used to derive location information for respective processing systems which, in turn, may use the network information or the location information to tag the document's location information which is in some way associated with the document for use in later searching for documents based on location information.

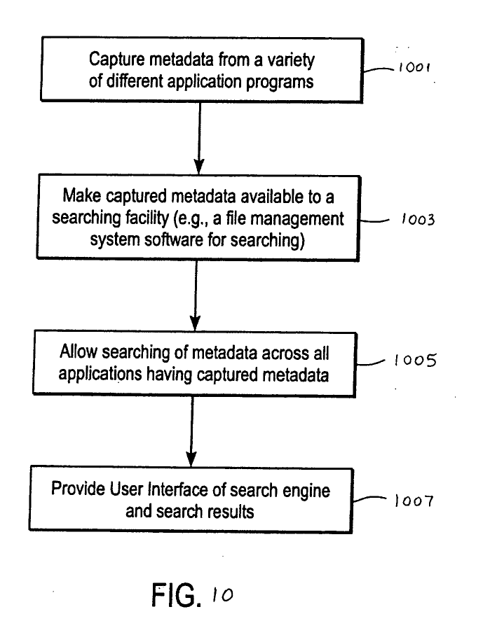

As noted above, one or more embodiments of the present invention may be utilized in a system which maintains a metadata database which captures metadata of different types of metadata information for different types of documents. FIG. 10 illustrates one exemplary method for capturing such metadata and maintaining such metadata such that it can be searched across all applications having captured metadata. The metadata is captured for a variety of different application programs; hence, the type of metadata in one type of file may be very different than the type of metadata for another type of file. This is shown in FIGS. 11A and 11B.

### Capturing and Use of Metadata Across a Variety of Application Programs

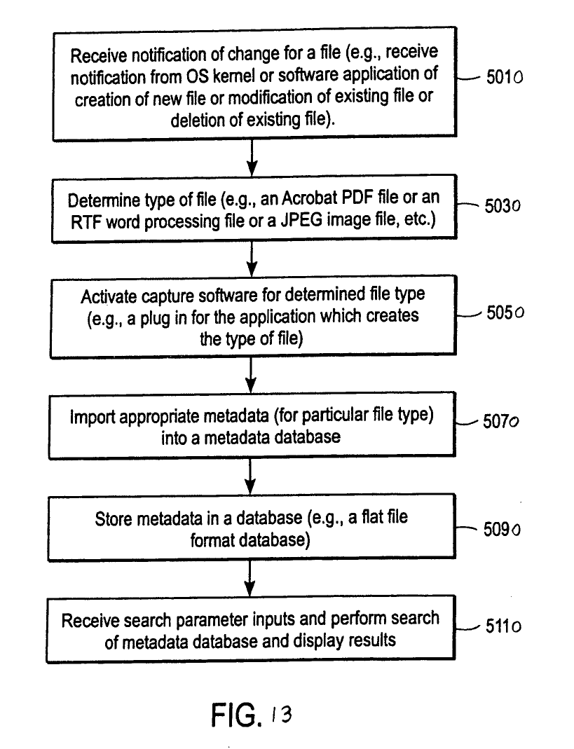

FIG. 10 shows a generalized example of one embodiment of the present invention. In this example, captured metadata is made available to a searching facility, such as a component of the operating system which allows concurrent searching of all metadata for all applications having captured metadata (and optionally for all non-metadata of the data files). The method of FIG. 10 may begin in operation 1001 in which metadata is captured from a variety of different application programs. This captured metadata is then made available in operation 1003 to a searching facility, such as a file management system software for searching. This searching facility allows, in operation 1005, the searching of metadata across all applications having captured metadata. The captured metadata may include the location information discussed above (e.g. location information derived from a network connection). The method also provides, in operation 1007, a user interface of a search engine and the search results which are obtained by the search engine. There are numerous possible implementations of the method of FIG. 10. For example, FIG. 13 shows a specific implementation of one exemplary embodiment of the method of FIG. 10. Alternative implementations may also be used. For example, in an alternative implementation, the metadata may be provided by each application program to a central source which stores the metadata for use by searching facilities and which is managed by an operating system component, which may be, for example, the metadata processing software. The user interface provided in operation 1007 may take a variety of different formats, including some of the examples described below as well as user interfaces which are conventional, prior art user interfaces. The metadata may be stored in a database which may be any of a variety of formats including a B tree format or, as described below, in a flat file format according to one embodiment of the invention.

The method of FIG. 10 may be implemented for programs which do not store or provide metadata. In this circumstance, a portion of the operating system provides for the capture of the metadata from the variety of different programs even though the programs have not been designed to provide or capture metadata. For those programs which do allow a user to create metadata for a particular document, certain embodiments of the present invention may allow the exporting back of captured metadata back into data files for applications which maintain metadata about their data files.

The method of FIG. 10 allows information about a variety of different files created by a variety of different application programs to be accessible by a system wide searching facility, which is similar to the way in which prior art versions of the Finder or Windows Explorer can search for file names, dates of creation, etc. across a variety of different application programs. Thus, the metadata for a variety of different files created by a variety of different application programs can be accessed through an extension of an operating system, and an example of such an extension is shown in FIG. 12 as a metadata processing software which interacts with other components of the system and will be described further below.

FIGS. 11A and 11B show two different metadata formats for two different types of data files. Note that there may be no overlap in any of the fields; in other words, no field in one type of metadata is the same as any field in the other type of metadata. Metadata format 1101 may be used for an image file such as a JPEG image file. This metadata may include information such as the image's width, the image's height, the image's color space, the number of bits per pixel, the ISO setting, the flash setting, the F/stop of the camera, the brand name of the camera which took the image, user-added keywords and other fields, such as a field which uniquely identifies the particular file, which identification is persistent through modifications of the file. Metadata format 1103 shown in FIG. 11B may be used for a music file such as an MP3 music file. The data in this metadata format may include an identification of the artist, the genre of the music, the name of the album, song names in the album or the song name of the particular file, song play times or the song play time of a particular song and other fields, such as a persistent file ID number which identifies the particular MP3 file from which the metadata was captured. Other types of fields may also be used.

One particular field which may be useful in the various metadata formats would be a field which includes an identifier of a plug in or other software element which may be used to capture metadata from a data file and/or export metadata back to the creator application.

Various different software architectures may be used to implement the functions and operations described herein. The following discussion provides one example of such an architecture, but it will be understood that alternative architectures may also be employed to achieve the same or similar results. The software architecture shown in FIG. 12 is an example which is based upon the Macintosh operating system. The architecture 400 includes a metadata processing software 401 and an operating system (OS) kernel 403 which is operatively coupled to the metadata processing software 401 for a notification mechanism which is described below. The metadata processing software 401 is also coupled to other software programs such as a file system graphical user interface software 405 (which may be the Finder), an email software 407, and other applications 409. These applications are coupled to the metadata processing software 401 through client application program interface 411 which provide a method for transferring data and commands between the metadata processing software 401 and the software 405, 407, and 409. These commands and data may include search parameters specified by a user as well as commands to perform searches from the user, which parameters and commands are passed to the metadata processing software 401 through the interface 411. The metadata processing software 401 is also coupled to a collection of importers 413 which extract data from various applications. An operating system may include a location importer which derives a location name, upon saving a document, from a network connection or from SPS coordinates. In particular, in one exemplary embodiment, a text importer is used to extract text and other information from word processing or text processing files created by word processing programs such as Microsoft Word, etc. This extracted information is the metadata for a particular file. Other types of importers extract metadata from other types of files, such as image files or music files. In this particular embodiment, a particular importer is selected based upon the type of file which has been created and modified by an application program. For example, if the data file was created by PhotoShop, then an image importer for PhotoShop may be used to input the metadata from a PhotoShop data file into the metadata database 415 through the metadata processing software 401. On the other hand, if the data file is a word processing document, then an importer designed to extract metadata from a word processing document is called upon to extract the metadata from the word processing data file and place it into the metadata database 415 through the metadata processing software 401. Typically, a plurality of different importers may be required in order to handle the plurality of different application programs which are used in a typical computer system. The importers 413 may optionally include a plurality of exporters which are capable of exporting the extracted metadata for particular types of data files back to property sheets or other data components maintained by certain application programs. For example, certain application programs may maintain some metadata for each data file created by the program, but this metadata is only a subset of the metadata extracted by an importer from this type of data file. In this instance, the exporter may export back additional metadata or may simply insert metadata into blank fields of metadata maintained by the application program.

The software architecture 400 also includes a file system directory 417 for the metadata. This file system directory keeps track of the relationship between the data files and their metadata and keeps track of the location of the metadata object (e.g. a metadata file which corresponds to the data file from which it was extracted) created by each importer. In one exemplary embodiment, the metadata database is maintained as a flat file format as described below, and the file system directory 417 maintains this flat file format. One advantage of a flat file format is that the data is laid out on a storage device as a string of data without references between fields from one metadata file (corresponding to a particular data file) to another metadata file (corresponding to another data file). This arrangement of data will often result in faster retrieval of information from the metadata database 415.

The software architecture 400 of FIG. 12 also includes find by content software 419 which is operatively coupled to a database 421 which includes a full text index of files. The index of files represents at least a subset of the data files in a storage device and may include all of the data files in a particular storage device (or several storage devices), such as the main hard drive of a computer system. The index of files may be a conventional indexed representation of the full text content of each document. The find by content software 419 searches for words in that content by searching through the database 421 to see if a particular word exists in any of the data files which have been indexed. The find by content software functionality is available through the metadata processing software 401 which provides the advantage to the user that the user can search concurrently both the index of files in the database 421 (for the content within a file) as well as the metadata for the various data files being searched. The software architecture shown in FIG. 12 may be used to perform the method shown in FIG. 13 or alternative architectures may be used to perform the method of FIG. 13.

The method of FIG. 13 may begin in operation 5010 in which a notification of a change for a file is received. This notification may come from the OS kernel 403 which notifies the metadata processing software 401 that a file has been changed. This notification may come from sniffer software elements which detect new or modified files and deletion of files. This change may be the creation of a new file or the modification of an existing file or the deletion of an existing file. The deletion of an existing file causes a special case of the processing method of FIG. 13 and is not shown in FIG. 13. In the case of a deletion, the metadata processing software 401, through the use of the file system directory 417, deletes the metadata file in the metadata database 415 which corresponds to the deleted file. The other types of operations, such as the creation of a new file or the modification of an existing file, causes the processing to proceed from operation 5010 to operation 5030 in which the type of file which is the subject of the notification is determined. The file may be an Acrobat PDF file or an RTF word processing file or a JPEG image file, etc. In any case, the type of the file is determined in operation 5030. This may be performed by receiving from the OS kernel 403 the type of file along with the notification or the metadata processing software 401 may request an identification of the type of file from the file system graphical user interface software 405 or similar software which maintains information about the data file, such as the creator application or parent application of the data file. It will be understood that in one exemplary embodiment, the file system graphical user interface software 405 is the Finder program which operates on the Macintosh operating system. In alternative embodiments, the file system graphical user interface system may be Windows Explorer which operates on Microsoft's Windows operating system. After the type of file has been determined in operation 5030, the appropriate capture software (e.g. one of the importers 413) is activated for the determined file type. The importers may be a plug-in for the particular application which created the type of file about which notification is received in operation 5010. Once activated, the importer or capture software imports the appropriate metadata (for the particular file type) into the metadata database, such as metadata database 415 as shown in operation 5070. Then in operation 5090, the metadata is stored in the database. In one exemplary embodiment, it may be stored in a flat file format. Then in operation 5110, the metadata processing software 401 receives search parameter inputs and performs a search of the metadata database (and optionally also causes a search of non-metadata sources such as the index of files 421) and causes the results of the search to be displayed in a user interface. This may be performed by exchanging information between one of the applications, such as the software 405 or the software 407 or the other applications 409 and the metadata processing software 401 through the interface 411. For example, the file system software 405 may present a graphical user interface, allowing a user to input search parameters and allowing the user to cause a search to be performed. This information is conveyed through the interface 411 to the metadata processing software 401 which causes a search through the metadata database 415 and also may cause a search through the database 421 of the indexed files in order to search for content within each data file which has been indexed. The results from these searches are provided by the metadata processing software 401 to the requesting application which, in the example given here, was the software 405, but it will be appreciated that other components of software, such as the email software 407, may be used to receive the search inputs and to provide a display of the search results. Various examples of the user interface for inputting search requests and for displaying search results are described herein and shown in the accompanying drawings.

It will be appreciated that the notification, if done through the OS kernel, is a global, system wide notification process such that changes to any file will cause a notification to be sent to the metadata processing software. It will also be appreciated that in alternative embodiments, each application program may itself generate the necessary metadata and provide the metadata directly to a metadata database without the requirement of a notification from an operating system kernel or from the intervention of importers, such as the importers 413, although notification may still be necessary to obtain location information from a network connection or from SPS coordinates. Alternatively, rather than using OS kernel notifications, an embodiment may use software calls from each application to a metadata processing software which receives these calls and then imports the metadata from each file in response to the call.

As noted above, the metadata database 415 may be stored in a flat file format in order to improve the speed of retrieval of information in most circumstances. The flat file format may be considered to be a non-B tree, non-hash tree format in which data is not attempted to be organized but is rather stored as a stream of data. Each metadata object or metadata file will itself contain fields, such as the fields shown in the examples of FIGS. 11A and 11B. However, there will typically be no relationship or reference or pointer from one field in one metadata file to the corresponding field (or another field) in the next metadata file or in another metadata file of the same file type.

A flexible query language may be used to search the metadata database in the same way that such query languages are used to search other databases. The data within each metadata file may be packed or even compressed if desirable. As noted above, each metadata file, in certain embodiments, will include a persistent identifier which uniquely identifies its corresponding data file. This identifier remains the same even if the name of the file is changed or the file is modified. This allows for the persistent association between the particular data file and its metadata.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine readable medium providing executable program instructions which, when executed by a data processing system, cause the data processing system to perform a method comprising:
determining, from a network connection, a representation of a location;
storing the representation of the location in association with a document for use in searching for documents based on location information.

2. A medium as in claim 1 wherein the determining is in response to a user's causing of the storing of the document.

3. A medium as in claim 1 wherein the document is one of a word processing document, a spreadsheet or other text-based documents.

4. A medium as in claim 1 wherein the storing of the representation of the location is in response to a user's saving of a newly created or modified user document which is the document.

5. A medium as in claim 1 wherein a plurality of locations are stored in association with the document.

6. A medium as in claim 1 wherein the representation of the location is stored in a metadata database on a storage device and the document is stored on the storage device.

7. A medium as in claim 1 wherein the representation of the location is stored as metadata of the document along with other metadata of the document.

8. A medium as in claim 6 wherein metadata in the metadata database includes different types of metadata for different types of documents.

9. A medium as in claim 8 wherein a full-text index database stores full text from the different types of documents.

10. A medium as in claim 1 wherein the network connection is a wireless connection that specifies a name which is used to specify a location.

11. A medium as in claim 10 wherein the representation of the location is at least one of (1) the name specified by the wireless connection or (2) a user specified name associated, by an action of a user, with the name specified by the wireless connection.

12. A medium as in claim 1 wherein the method further comprises:
receiving a search query which includes location data;
performing a search using the search query;
presenting a result of the search.

13. A medium as in claim 8 wherein the method further comprises:
receiving a satellite positioning system (SPS) data which specify a further location where a further document was first created or modified;
converting the SPS data to a user friendly location;
storing the user friendly location in association with the further document, the user friendly location being stored as metadata, of the further document, in the metadata database.

14. A medium as in claim 1, the method further comprising:
presenting a user interface to allow inputting of a user specified location name to be associated with the network connection, wherein, after the inputting, the user specified location name is the representation of the location.

15. A machine readable medium providing executable program instructions which, when executed by a data processing system, cause the data processing system to perform a method comprising:
obtaining data representing a geographical location in response to storing or creating or modifying a document;
associating the data representing the geographical location with the document, wherein the document is capable of being one of a plurality of different types including a text-based document with ASCII characters within the content of the document.

16. A medium as in claim 15 wherein the obtaining is in response to a user's causing of the storing of the document.

17. A medium as in claim 15 wherein the associating comprises storing the data representing the geographical location as metadata for the document with other metadata for the document.

18. A medium as in claim 17 wherein the metadata and the other metadata are stored in a metadata database, and wherein the metadata database and the document are stored on a storage device.

19. A medium as in claim 18 wherein the metadata database includes different types of metadata for different types of documents and wherein a full-text index database stores full text from the different types of documents.

20. A medium as in claim 18 wherein the obtaining comprises at least one of (1) determining, from a network connection, the geographical location or (2) deriving the geographical location from satellite positioning system (SPS) coordinates.

21. A medium as in claim 20 wherein the method further comprises:
receiving a search query which includes location data;
performing a search using the search query, wherein the location data is used to search a location field in the metadata database;
presenting a result of the search.

22. A machine readable medium providing executable program instructions which, when executed by a data processing system, cause the data processing system to perform a method comprising:
obtaining data representing a geographical location in response to creating or modifying a document;
associating the data representing the geographical location with the document, wherein the data representing the geographical location is stored as metadata for the document in a metadata database having different types of metadata for different types of documents.

23. A medium as in claim 22 wherein the obtaining is in response to a user's causing of the storing of the document.

24. A medium as in claim 22 wherein the obtaining comprises at least one of (1) determining, from a network connection, the geographic location or (2) deriving the geographical location from satellite positioning system (SPS) coordinates.

25. A medium as in claim 22 wherein the method further comprises:
receiving a search query which includes location data;
performing a search through the metadata database using the search query, wherein the location data is used to search through location fields in the metadata database;
presenting a result of the search.

26. A medium as in claim 25 wherein the method further comprises:
performing a search through a full-text index database using the search query.

27. A medium as in claim 24 wherein the network connection is a wireless connection that specifies a name which is used to specify a location.

28. A medium as in claim 27 wherein the data representing a geographical location is at least one of (1) the name specified by the wireless connection or (2) a user specified name associated, by an action of a user, with the name specified by the wireless connection.

29. A machine implemented method comprising:
determining, from a network connection, a representation of a location;
storing the representation of the location in association with a document for use in searching for documents based on location information.

30. A method as in claim 29 wherein the determining is in response to a user's causing of the storing of the document.

31. A method as in claim 29 wherein the document is one of a word processing document, a spreadsheet or other text-based documents.

32. A method as in claim 29 wherein the storing of the representation of the location is in response to a user's saving of a newly created or modified user document which is the document.

33. A method as in claim 29 wherein a plurality of locations are stored in association with the document.

34. A method as in claim 29 wherein the representation of the location is stored in a metadata database on a storage device and the document is stored on the storage device.

35. A method as in claim 29 wherein the representation of the location is stored as metadata of the document along with other metadata of the document.

36. A method as in claim 34 wherein metadata in the metadata database includes different types of metadata for different types of documents.

37. A method as in claim 36 wherein a full-text index database stores full text from the different types of documents.

38. A method as in claim 29 wherein the network connection is a wireless connection that specifies a name which is used to specify a location.

39. A method as in claim 38 wherein the representation of the location is at least one of (1) the name specified by the wireless connection or (2) a user specified name associated, by an action of a user, with the name specified by the wireless connection.

40. A method as in claim 29 further comprising:
receiving a search query which includes location data;
performing a search using the search query;
presenting a result of the search.

41. A method as in claim 36 wherein the method further comprises:
receiving a satellite positioning system (SPS) data which specify a further location where a further document was first created or modified;
converting the SPS data to a user friendly location;
storing the user friendly location in association with the further document, the user friendly location being stored as metadata, of the further document, in the metadata database.

42. A method as in claim 29, the method further comprising:
presenting a user interface to allow inputting of a user specified location name to be associated with the network connection, wherein, after the inputting, the user specified location name is the representation of the location.

43. A machine implemented method comprising:
obtaining data representing a geographical location in response to storing or creating or modifying a document;
associating the data representing the geographical location with the document, wherein the document is capable of being one of a plurality of different types including a text-based document with ASCII characters within the content of the document.

44. A method as in claim 43 wherein the obtaining is in response to a user's causing of the storing of the document.

45. A method as in claim 43 wherein the associating comprises storing the data representing the geographical location as metadata for the document with other metadata for the document.

46. A method as in claim 45 wherein the metadata and the other metadata are stored in a metadata database, and wherein the metadata database and the document are stored on a storage device.

47. A method as in claim 46 wherein the metadata database includes different types of metadata for different types of documents and wherein a full-text index database stores full text from the different types of documents.

48. A method as in claim 46 wherein the obtaining comprises at least one of (1) determining, from a network connection, the geographical location or (2) deriving the geographical location from satellite positioning system (SPS) coordinates.

49. A method as in claim 48 wherein the method further comprises:
receiving a search query which includes location data;
performing a search using the search query, wherein the location data is used to search a location field in the metadata database;
presenting a result of the search.

50. A machine implemented method comprising:
obtaining data representing a geographical location in response to creating or modifying a document;
associating the data representing the geographical location with the document, wherein the data representing the geographical location is stored as metadata for the document in a metadata database having different types of metadata for different types of documents.

51. A method as in claim 50 wherein the obtaining is in response to a user's causing of the storing of the document.

52. A method as in claim 50 wherein the obtaining comprises at least one of (1) determining, from a network connection, the geographic location or (2) deriving the geographical location from satellite positioning system (SPS) coordinates.

53. A method as in claim 50 wherein the method further comprises:
receiving a search query which includes location data;
performing a search through the metadata database using the search query, wherein the location data is used to search through location fields in the metadata database;
presenting a result of the search.

54. A method as in claim 53 wherein the method further comprises:
performing a search through a full-text index database using the search query.

55. A method as in claim 52 wherein the network connection is a wireless connection that specifies a name which is used to specify a location.

56. A method as in claim 55 wherein the data representing a geographical location is at least one of (1) the name specified by the wireless connection or (2) a user specified name associated, by an action of a user, with the name specified by the wireless connection.

57. A data processing system comprising:
means for determining, from a network connection, a representation of a location;
means for storing the representation of the location in association with a document for use in searching for documents based on location information.

58. A data processing system comprising:
means for obtaining data representing a geographical location in response to storing or creating or modifying a document;
means for associating the data representing the geographical location with the document, wherein the document is capable of being one of a plurality of different types including a text-based document with ASCII characters within the content of the document.

59. A data processing system comprising:
means for obtaining data representing a geographical location in response to creating or modifying a document;
means for associating the data representing the geographical location with the document, wherein the data representing the geographical location is stored as metadata for the document in a metadata database having different types of metadata for different types of documents.

60. A machine implemented method comprising:
receiving a search query which includes a representation of a geographical location;
performing a search, using the search query, through information including at least one document having a representation of a location, determined from a network connection, which is stored in association with the document.

61. A machine readable medium containing executable program instructions which when executed by a data processing system cause the data processing system to perform a method comprising:
receiving a search query which includes a representation of a geographical location;
performing a search, using the search query, through information including at least one document having a representation of a location, determined from a network connection, which is stored in association with the document.

62. A machine implemented method comprising:
receiving a search query which includes a representation of a geographic location;
performing a search, using the search query, through information including at least one document having a representation of a location obtained in response to storing or creating or modifying the document, and wherein the document is capable of being one of a plurality of different types including a text-based document with ASCII characters within the content of the document.

63. A machine readable medium containing executable program instructions which when executed by a data processing system cause the data processing system to perform a method comprising:
receiving a search query which includes a representation of a geographic location;
performing a search, using the search query, through information including at least one document having a representation of a location obtained in response to storing or creating or modifying the document, and wherein the document is capable of being one of a plurality of different types including a text-based document with ASCII characters within the content of the document.

64. A machine implemented method comprising:
receiving a search query which includes a representation of a geographical location;
performing a search, using the search query, through a metadata database containing location metadata of at least one document, the location metadata having been obtained in response to storing or creating or modifying the at least one document, wherein the metadata database has different types of metadata for different types of documents.

65. A machine readable medium containing executable program instructions which when executed by a data processing system cause the data processing system to perform a method comprising:
receiving a search query which includes a representation of a geographical location;
performing a search, using the search query, through a metadata database containing location metadata of at least one document, the location metadata having been obtained in response to storing or creating or modifying the at least one document, wherein the metadata database has different types of metadata for different types of documents.
